(19) United States
(12) Patent Application Publication
(10) Pub. No.: US 2015/0205396 A1
(43) Pub. Date: Jul. 23, 2015

(54) INFORMATION PROCESSING DEVICE, INFORMATION TERMINAL, INFORMATION PROCESSING SYSTEM AND CALIBRATION METHOD

(71) Applicant: MITSUBISHI ELECTRIC CORPORATION, Tokyo (JP)

(72) Inventors: Yasutaka Konishi, Tokyo (JP); Atsushi Matsumoto, Tokyo (JP)

(73) Assignee: MITSUBISHI ELECTRIC CORPORATION, Tokyo (JP)

(21) Appl. No.: 14/413,843

(22) PCT Filed: Oct. 19, 2012
(86) PCT No.: PCT/JP2012/077124

§ 371 Date: Jan. 9, 2015

(51) Int. Cl. G06F 3/041

(52) U.S. Cl. CPC G06F 3/041

(57) ABSTRACT

An information processing device includes: an operation region acquisition unit 14 that performs image analysis to a screen of a touch panel display 13 on which a screen of a portable terminal 2 is displayed by a display control unit 12, and acquires operation region information for identifying a touch operation region corresponding to the screen of the terminal 2; a touch operation information acquisition unit 16 that detects a touch operation to the display 13 and acquires position information of touch operation detected based on the region information; and a coordinate transformation unit 17 that transforms, based on the region information, position information of the touch operation acquired by the unit 16 into position information corresponding to the screen of the terminal 2, thereby remotely operating the terminal 2 by an operation/control information communication unit 18 sending the transformed position information to the terminal 2 as remote operation information.

### TECHNICAL FIELD

The present invention relates to an information processing device, an information processing system, and a calibration method of a touch operation region in which, when an information processing device including a display having a touch panel function (hereinafter referred to as a “touch panel display”) is to remotely operate an information terminal, calibration information for transforming a user operation input into the touch panel display of the information processing device into an operation performed to the information terminal.

### BACKGROUND ART

Conventionally, technologies have been proposed for connecting an information processing device including a touch panel display such as an in-car navigation device and an information terminal including a touch panel display such as a mobile phone via WiFi or USB, displaying the screen information of the information terminal on the touch panel display of the information processing device, and allowing the information processing device to remotely operate the information terminal by sending the operation information input via the touch panel display to the information terminal.

With the conventional remote operation technologies, since the resolution or aspect ratio of the touch panel display of the information processing device does not necessarily coincide with that of the touch panel display of the information terminal, processing of transforming the touch position coordinate on the touch panel display of the information processing device into the position coordinate on the touch panel display of the information terminal is required.

Nevertheless, when digitally outputting the screen information from the information terminal to the information processing device, the information terminal adds a peripheral region such as a black belt (hereinafter referred to as the “black belt region”) to the screen information to be output to match the resolution that is compatible with both the information terminal and the information processing device. Thus, with the information processing device that displays screen information to which a black belt region has been added, displayed is screen information having a display region that is different for each information terminal model. Accordingly, in order to transform the touch position coordinate on the touch panel display of the information processing device into the position coordinate on the touch panel display of the information terminal, an operable region of the information terminal needs to be set in advance in the in-car navigation.

As the foregoing measure, Patent Document 1 discloses the following configuration: an information processing device comprises: an imaging unit that images a display screen of a display unit of an information terminal and generates image data, and an imaging range and magnification of the imaging unit are adjusted so that the display screen of the information terminal fits within an index range showing the detected range of the touch operation input to the information processing device, and the touch operation region of the information terminal is set in advance in the information processing device. Moreover, Patent Document 1 discloses an operation method of storing an information terminal in a fixed case, imaging the display screen of the information terminal with the imaging unit mounted on a cover part of the fixed case, thereby causing the display screen of the information terminal to coincide with the index range of the information processing device.

### CITATION LIST

### Patent Document

Patent Document 1: Japanese Patent Application Laid-open No. 2012-3374

### SUMMARY OF THE INVENTION

### Problems to be Solved by the Invention

Nevertheless, with the technology disclosed in Patent Document 1, a user is required to take a picture of the display screen of the information terminal so that the display screen fits within the index range of the information processing device while operating the imaging unit, and there is a problem such that the touch operation region of the information terminal cannot be accurately set in the information processing device in a short period of time. Moreover, with the method of using the fixed case, a setting of the imaging unit needs to be set for each information terminal since a terminal size differs for each information terminal, and there is a problem such that versatility is inferior.

The present invention is made to solve the foregoing problems, and an object of the invention is to accurately and easily acquire a touch operation region of output screen information (information in which a black belt region is added to screen information) of an information terminal that is digitally output on a touch panel display of an information processing device.

### Means for Solving the Problems

An information processing device according to the present invention includes: a display controller that displays a screen of an information terminal on a display by using screen information of the information terminal received from a communicator; an operation region acquisition unit that performs image analysis to a screen of the display on which the screen of the information terminal is displayed, and acquires operation region information for identifying a touch operation region corresponding to the screen of the information terminal; a touch operation acquisition unit that detects a touch operation performed to a touch panel, and acquires position information of the detected touch operation based on the operation region information; and a touch coordinate transformer that transforms, based on the operation region information, the position information of the touch operation acquired by the touch operation acquisition unit into position information corresponding to the screen of the information terminal, wherein the communicator sends the position information transformed by the touch coordinate transformer to the information terminal as remote operation information, thereby remotely operating the information terminal.

### Effect of the Invention

According to the present invention, it is possible to accurately and easily acquire the touch operation region of the output screen information of then information terminal that is digitally output on the display of the touch panel of the information processing device, and easily generate and set information for transforming the touch operation input to the touch panel display of the information processing device into an operation performed to the information terminal.

### BRIEF DESCRIPTION OF THE DRAWINGS

FIG. 1 is a block diagram showing a configuration of an information processing system according to Embodiment 1.

FIG. 2 is a diagram showing an example of the display processing of the information processing system according to Embodiment 1.

FIG. 3 is a diagram showing an example of image analysis processing performed by an operation region acquisition unit of the information processing system according to Embodiment 1.

FIG. 4 is a diagram showing the coordinate transformation processing performed by a coordinate transformation unit of the information processing system according to Embodiment 1.

FIG. 5 is a flowchart showing calibration processing of the information processing system according to Embodiment 1.

FIG. 6 is a flowchart showing coordinate transformation processing of the information processing system according to Embodiment 1.

FIG. 7 is a block diagram showing another configuration of the information processing system according to Embodiment 1.

FIG. 8 is a block diagram showing a configuration of an information processing system according to Embodiment 2.

FIG. 9 is a diagram showing an example of calibration processing of the information processing system according to Embodiment 2.

FIG. 10 is a diagram showing an example of the calibration processing of the information processing system according to Embodiment 2.

FIG. 11 is a flowchart showing the calibration processing of the information processing system according to Embodiment 2.

FIG. 12 is a block diagram showing a configuration of an information processing system according to Embodiment 3.

FIG. 13 is a flowchart showing screen direction detection processing of the information processing system according to Embodiment 3.

FIG. 14 is a flowchart showing calibration processing of the information processing system according to Embodiment 3.

FIG. 15 is a block diagram showing a configuration of an information processing system according to Embodiment 4.

FIG. 16 is a diagram showing a display example of the information processing system according to Embodiment 4.

FIG. 17 is a flowchart showing calibration processing of the information processing system according to Embodiment 4.

FIG. 18 is a block diagram showing a configuration of an information processing system according to Embodiment 5.

FIG. 19 is a flowchart showing calibration processing of the information processing system according to Embodiment 5.

FIG. 20 is a block diagram showing another configuration of the information processing system according to Embodiment 5.

FIG. 21 is a block diagram showing a configuration of an information processing system according to Embodiment 6.

FIG. 22 is a flowchart showing accumulation and search processing of the operation region information of the information processing system according to Embodiment 6.

### MODES FOR CARRYING OUT THE INVENTION

In the following, in order to describe the present invention in more detail, embodiments for carrying out the invention will be described with reference to the accompanying drawings.

### Embodiment 1

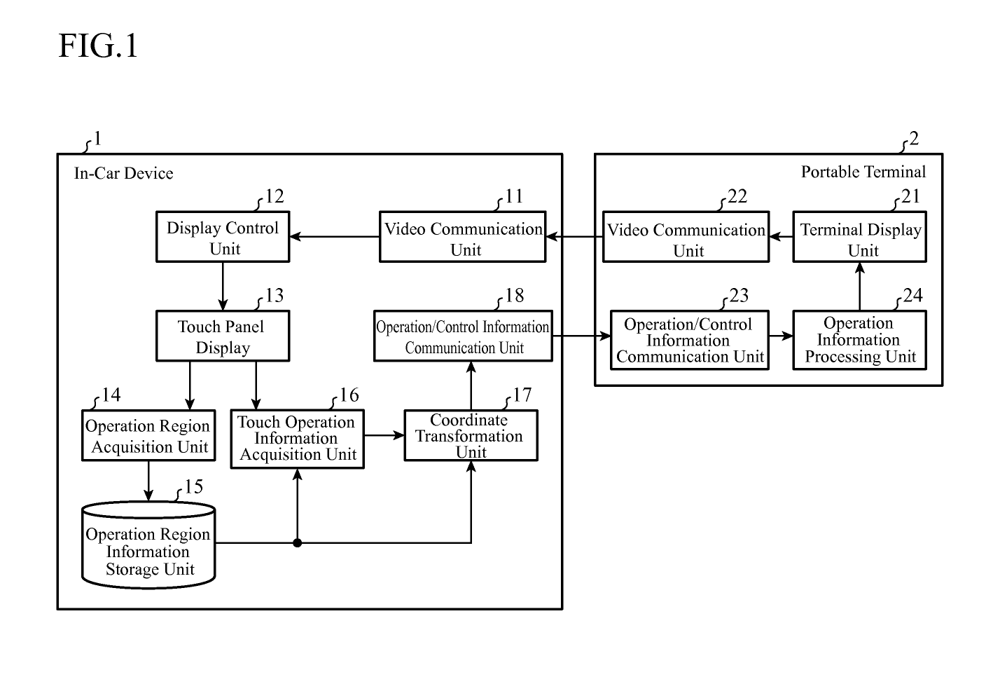

FIG. 1 is a block diagram showing a configuration of an information processing system according to Embodiment 1 of the present invention.

In an example of FIG. 1, the information processing system is configured by using an in-car device 1 as an information processing device and a portable terminal 2 as an information terminal.

The in-car device 1 is an in-car electronic device including a touch panel display and is, for example, a car navigation system, a display audio, or an in-car display. The portable terminal 2 is an electronic component having a function capable of communicating with the in-car device 1 and having a touch panel display, and includes, for example, a smartphone, a mobile phone, a PHS, a PDA, a portable media player, a digital camera, or a digital video camera.

The respective configurations of the in-car device 1 and the portable terminal 2 are now explained in detail.

The in-car device 1 comprises a video communication unit 11, a display control unit 12, a touch panel display 13, an operation region acquisition unit 14, an operation region information storage unit 15, a touch operation information acquisition unit (touch operation acquisition unit) 16, a coordinate transformation unit (touch coordinate transformation unit) 17 and an operation/control information communication unit 18. The portable terminal 2 comprises a terminal display unit 21, a video communication unit 22, an operation/control information communication unit 23 and an operation information processing unit 24.

The video communication unit 11 of the in-car device 1 performs data communication with the video communication unit 22 of the portable terminal 2 via a USB (Universal Serial Bus), wireless LAN, HDMI (High Definition Multimedia Interface), MHL (Mobile High-Definition Link) or the like, and acquires output screen information of the portable terminal 2. Here, the term “output screen information” refers to information in which a peripheral region (hereinafter referred to as “black belt region”) having a brightness that differs from the screen information is added to the screen information of the portable terminal 2. Note that the details will be explained later.

The display control unit 12 performs display control of displaying, on the touch panel display 13, the output screen information acquired by the video communication unit 11. The touch panel display 13 displays the output screen information of the portable terminal 2 on the display based on the display control of the display control unit 12. Moreover, the touch panel display 13 receives a user operation that is input to the output screen information of the portable terminal 2 displayed on the display.

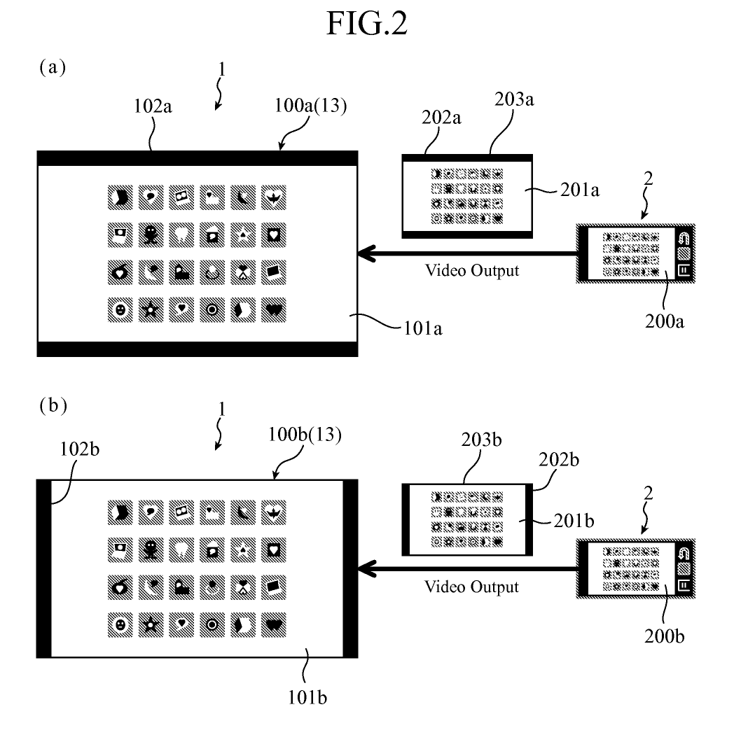

The display processing of displaying the screen information of the portable terminal 2 on the display screen of the touch panel display 13 is now explained with reference to FIG. 2.

The terminal display unit 21 of the portable terminal 2 has a screen 200a and a screen 200b that respectively have different sizes for each model. Regions 202a, 202b outside the operation screen display regions, which are the black belt regions, are added to operation screen display regions 201a, 201b configuring the screen 200a or the screen 200b, and sent as output screen information 203a, 203b to the in-car device 1 via the video communication unit 22. The regions 202a, 202b outside the operation screen display regions to be added are also different for each terminal, and in an example shown in FIG. 2(a), the region 202a outside the operation screen display region is disposed on the long side of the rectangular operation screen display region 201a, and in an example of FIG. 2(b), the region 202b outside the operation screen display region is disposed on the short side of the rectangular operation screen display region 201b.

The output screen information 203a, 203b received by the video communication unit 11 of the in-car device 1 is input to the display control unit 12, and displayed as portable terminal output screens 100a, 100b on the touch panel display 13 based on the display control of the display control unit 12. The portable terminal output screens 100a, 100b are configured from touch operation regions 101a, 101b on which the display screen of the portable terminal 2 is displayed, and regions 102a, 102b outside the touch operation regions adjacent to the touch region on which the black belt region is displayed.

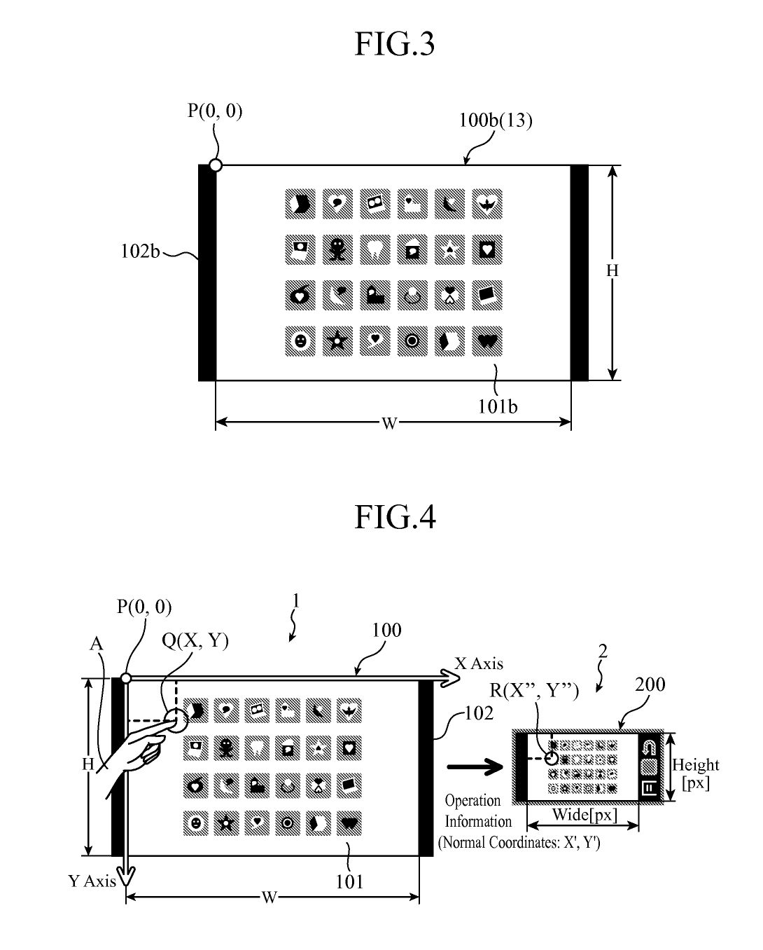

Subsequently, the operation region acquisition unit 14 performs image analysis to the portable terminal output screens 100a, 100b displayed on the touch panel display 13. An example of the image analysis processing performed by the operation region acquisition unit 14 is now explained with reference to FIG. 3.

The operation region acquisition unit 14 performs binarization processing to the portable terminal output screen 100b, and acquires a binarization image. Since the touch operation region 101b and the region 102b outside the touch operation region are regions having a different brightness, for instance, the touch operation region 101b is displayed in white and the region 102b outside the touch operation region is displayed in black based on the binarization image, and it is thereby possible to detect the boundary between the touch operation region 101b and the region 102b outside the touch operation region. The touch operation region 101b is identified based on the detected boundary, and a starting point position P(0, 0) of the identified touch operation region 101b and size information indicated as a horizontal width W and a vertical height H of the touch operation region 101b are acquired. The starting point position P and the size information are information that is required upon transforming a touch operation input via the touch panel display 13 of the in-car device 1 into a touch coordinate of the portable terminal 2. The acquired starting point position P and the size information of the touch operation region 101b are stored, as operation region information, in the operation region information storage unit 15.

The touch operation information acquisition unit 16 acquires a user's touch state and a touch position coordinate for the touch panel display 13. The coordinate transformation unit 17 transforms or converts the touch position coordinate acquired by the touch operation information acquisition unit 16 into a coordinate for obtaining the position coordinate on the side of the portable terminal 2 based on the operation region information stored in the operation region information storage unit 15. Details regarding the coordinate transformation processing will be explained later. The operation/control information communication unit 18 sends the coordinate transformed by the coordinate transformation unit 17, as operation information, to the portable terminal 2. The operation/control information communication unit 18 performs data communication with the operation/control information communication unit 23 of the portable terminal 2 via a USB, wireless LAN, HDMI, MHL, Bluetooth (registered trademark; this description is hereinafter omitted) or the like.

The video communication unit 11 and the operation/control information communication unit 18 of the in-car device 1 sends a connection request to the in-car device 1 and the portable terminal 2 at the timing that the in-car device 1 is activated, and connects both of the device and terminal. It is thereby possible to automatically connect the in-car device 1 and the portable terminal 2 when the in-car device 1 is activated. After the connection of the in-car device 1 and the portable terminal 2 is established, the in-car device 1 acquires the operation region information of the portable terminal output screen. Note that, when the connection is a wired connection via HDMI, for instance, a connection method of the in-car device 1 and the portable terminal 2 may be suitably selected since a manual connection by the user is considered. Note that, while FIG. 1 illustrates a configuration of providing a video communication unit 11 and an operation/control information communication unit 18, the configuration may also be such that one communication unit communicates a video, operation information and control information.

The configuration of the portable terminal 2 is now explained.

The terminal display unit 21 displays on the screen an application that is activated on the portable terminal 2. The video communication unit 22 outputs the screen information of the application screen displayed on the terminal display unit 21 to the side of the in-car device 1. The operation/control information communication unit 23 receives, via the operation/control information communication unit 18, the operation information obtained by the coordinate transformation unit 17 of the in-car device 1, and notifies the received operation information to the operation information processing unit 24. The operation information processing unit 24 acquires a coordinate value from the notified operation information, and transforms the acquired coordinate value into a coordinate corresponding to the display screen of the terminal display unit 21. The application is controlled based on the transformed coordinate value.

As described above, the touch operation into the touch panel display 13 of the in-car device 1 is converted into an operation instruction to the screen information of the portable terminal 2, the application is controlled based on the transformed operation instruction, and the application screen which is the control result is displayed on the terminal display unit 21.

The coordinate transformation processing is now explained with reference to FIG. 4.

When the user performs an operation input A to the touch panel display 13 of the in-car device 1, the touch operation information acquisition unit 16 detects the operation input A, and acquires a touch position coordinate Q(X, Y) of the operation input A based on the starting point position P of the operation region information stored in the operation region information storage unit 15. The coordinate transformation unit 17 performs normal coordinate transformation using the touch position coordinate (X, Y) acquired by the touch operation information acquisition unit 16, and the size information (horizontal width W and vertical height H of the touch operation region) of the operation region information stored in the operation region information storage unit 15, and acquires a normal coordinate (X′, Y′).

The normal coordinate transformation is represented with Formula (1) below.

$${X}^{′} = ( \frac{X}{W} ) \\ {Y}^{′} = ( \frac{Y}{H} ) \qquad ( 1 )$$

The normal coordinate (X′, Y′) acquired by the coordinate transformation unit 17 is sent as the operation information to the side of the portable terminal 2 via the operation/control information communication unit 18. The operation information processing unit 24 of the portable terminal 2 performs processing of transforming the normal coordinate (X′, Y′), which is the operation information received via the operation/control information communication unit 23, into a coordinate (X″, Y″) corresponding to a display size (horizontal width: Wide[px], vertical height: Height[px]) of the terminal display unit 21. Transformation into the coordinate corresponding to the display size of the terminal display unit 21 is represented with Formula (2) below.

X″=X′×Wide

Y″=Y′×Height (2)

The transformed coordinate (X″, Y″) will become a touch operation region R of the screen information of the portable terminal 2.

An operation of the information processing system is now explained.

Note that, in the following, explained is a case where the video communication unit 11 of the in-car device 1 and the video communication unit 22 of the portable terminal 2 are connected via HDMI, and the operation/control information communication unit 18 of the in-car device 1 and the operation/control information communication unit 23 of the portable terminal 2 are connected via Bluetooth. Moreover, an explanation of the operation of the information processing system will be provided by being separated into calibration processing of acquiring and accumulating the operation region information, and the coordinate transformation processing of transforming the touch operation input to the touch panel display 13 into the coordinate of the terminal display unit 21 of the portable terminal 2.

The calibration processing is foremost explained.

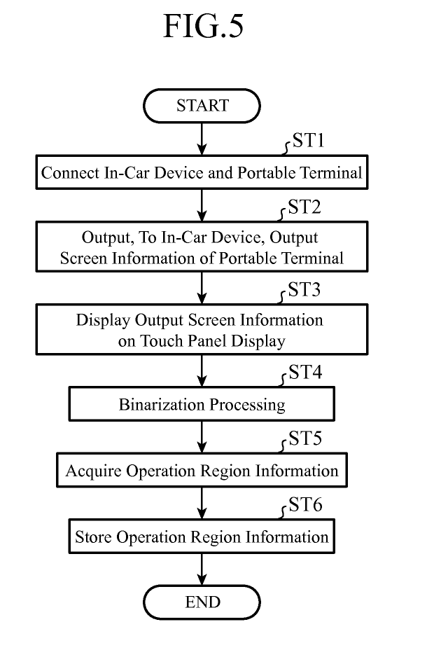

FIG. 5 is a flowchart showing the calibration processing of the information processing system according to Embodiment 1 of the present invention.

The in-car device 1 and the portable terminal 2 are connected via HDMI and Bluetooth (step ST1). Note that the Bluetooth connection processing is performed when the in-car device 1 is activated. The video communication unit 22 of the portable terminal 2 outputs, to the side of the in-car device 1, the output screen information of the terminal display unit 21 via HDMI (step ST2). The in-car device 1 receives the output screen information output in step ST2 with the display control unit 12 via the video communication unit 11, and displays the received output screen information on the display screen of the touch panel display 13 (step ST3).

The operation region acquisition unit 14 performs binarization processing to the output screen information displayed on the display screen of the touch panel display 13, and detects the screen information and the boundary of the black belt region from the acquired binarization image (step ST4). The operation region acquisition unit 14 identifies the touch operation region based on the detected boundary, and acquires the starting point position and the size information of the identified touch operation region (step ST5). The acquired starting point position and size information are stored as the operation region information in the operation region information storage unit 15 (step ST6), and the calibration processing is thereby ended.

Note that the configuration may also be such that the communication connection with the portable terminal 2 which is detected as communicable is also started to execute the calibration processing when the in-car device 1 is activated. Consequently, the user will no longer be required to perform the connection setting and calibration setting in the in-car device 1 and the portable terminal 2. Moreover, the configuration may also be such that, among the portable terminals that are detected as communicable, the user selects his/her desired portable terminal and establishes communication connection, and thereafter executes the calibration processing.

The coordinate transformation processing is now explained.

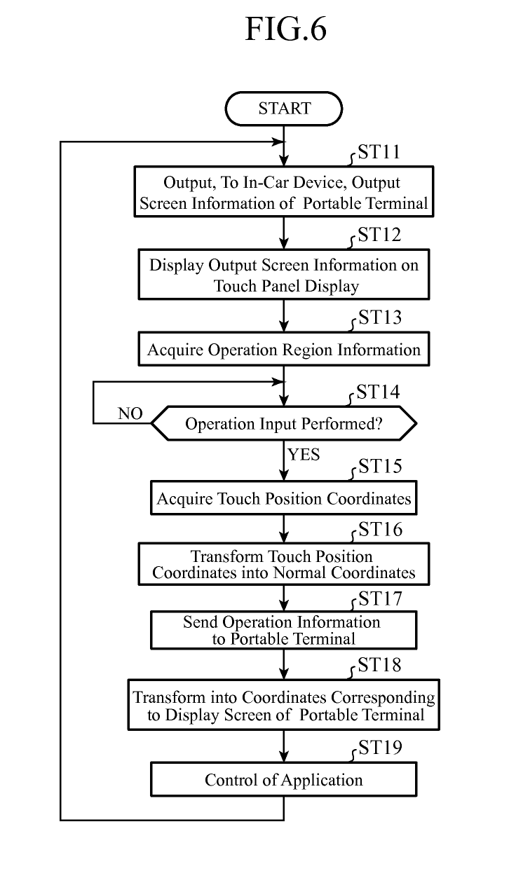

FIG. 6 is a flowchart showing the coordinate transformation processing of the information processing system according to Embodiment 1 of the present invention. Note that, in an example of FIG. 6, an explanation is provided on the assumption that the communication between the in-car device 1 and the portable terminal 2 has already been established.

The video communication unit 22 of the portable terminal 2 outputs to the side of the in-car device 1 the output screen information of the terminal display unit 21 via HDMI (step ST11). The in-car device 1 receives the output screen information output in step ST11 with the display control unit 12 via the video communication unit 11, and displays the received output screen information on the display screen of the touch panel display 13 (step ST12). When the output screen information is displayed on the touch panel display 13, the touch operation information acquisition unit 16 and the coordinate transformation unit 17 acquire the operation region information stored in the operation region information storage unit 15 (step ST13).

In addition, the touch operation information acquisition unit 16 determines whether an operation input has been performed to the touch panel display 13 (step ST14). When the operation input has not been performed (step ST14: NO), the routine returns to the determination processing of step ST14. Meanwhile, when the operation input has been performed (step ST14; YES), the touch operation information acquisition unit 16 refers to the operation region information acquired in step ST13, and acquires the touch position coordinate corresponding to the operation input (step ST15). The coordinate transformation unit 17 refers to the operation region information acquired in step ST13, performs normal coordinate transformation to the touch position coordinate acquired in step ST15, and thereby acquires the normal coordinate (step ST16).

The operation/control information communication unit 18 sends as the operation information the normal coordinate acquired in step ST16 to the side of the portable terminal 2 (step ST17). The operation information processing unit 24 of the portable terminal 2 acquires the operation information sent in step ST17 via the operation/control information communication unit 23 of the portable terminal 2, and transforms the normal coordinate corresponding to the operation input as the operation information into the coordinate corresponding to the screen information of the portable terminal 2 (step ST18). In addition, the operation information processing unit 24 controls the application of the portable terminal 2 based on the coordinate value of the coordinate transformed in step ST18, and displays the application screen based on the control on the terminal display unit 21 (step ST19). Subsequently, the flow returns to the processing of step ST11, and the foregoing processing is repeated.

A different configuration for the coordinate transformation processing of the information processing system of Embodiment 1 is now explained.

With the foregoing coordinate transformation processing, the in-car device 1 performed normal coordinate transformation to the touch position coordinate and acquired the thus obtained normal coordinate, output the acquired normal coordinate to the portable terminal 2 as the operation information, and the portable terminal 2 transformed the normal coordinate into the coordinate corresponding to the display screen. Meanwhile, the configuration may also be such that the in-car device 1 performs the processing of transforming the normal coordinate into the coordinate corresponding to the screen information of the portable terminal 2.

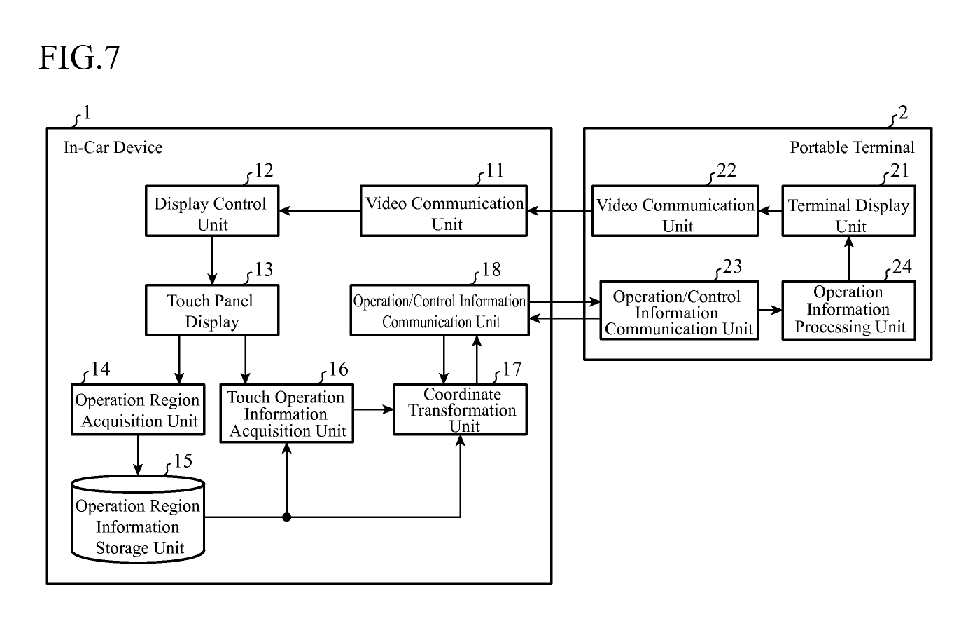

FIG. 7 is a block diagram showing another configuration of the information processing system according to Embodiment 1 of the present invention.

In FIG. 7, an arrow heading from the operation/control information communication unit 23 of the portable terminal 2 to the operation/control information communication unit 18 of the in-car device 1, and an arrow heading from the operation/control information communication unit 18 of the in-car device 1 to the coordinate transformation unit 17 have been added. This shows that the size information (horizontal width: Wide[px], vertical height: Height[px]) of the display screen of the portable terminal 2 is output in advance to the side of the in-car device 1 via the operation/control information communication unit 23 of the portable terminal 2. The size information of the display screen input to the side of the in-car device 1 is stored in a storage region (not shown) or the like of the coordinate transformation unit that is input to the coordinate transformation unit 17 via the operation/control information communication unit 18 of the in-car device 1.

As a processing operation of the coordinate transformation processing, the coordinate transformation unit 17 transforms the touch position coordinate of the operation input to the touch panel display 13 into the normal coordinate, and thereafter uses the size information of the display screen of the portable terminal 2 which is stored in advance, and transforms the normal coordinate into the coordinate corresponding to the display screen. The transformed coordinate corresponding to the display screen is output as the operation information to the side of the portable terminal 2. The operation information processing unit 24 of the portable terminal 2 controls the application of the portable terminal 2 based on the coordinate value indicated in the notified operation information.

Note that the foregoing calibration processing by the operation region acquisition unit 14 is also performed in cases where the in-car device 1 transforms the normal coordinate into the coordinate corresponding to the display screen of the terminal display unit 21 of the portable terminal 2.

As described above, according to Embodiment 1, when the in-car device 1 and portable terminal 2 comprising a touch panel display having different resolutions and/or display sizes are connected, and the portable terminal 2 is to be remotely operated by the in-car device 1, the operation region acquisition unit 14 that performs calibration processing of determining the touch operation region in the output screen information of the portable terminal 2, and acquiring and storing the operation region information of the determined touch operation region has been additionally provided to the configuration; thus, even in cases where the size of the portable terminal output screen differs for each portable terminal model, the touch position coordinate of the user operation input to the touch panel display of the in-car device can be easily transformed into the coordinate corresponding to the display screen of the portable terminal. Consequently, when the portable terminal is to be remotely operated using the in-car device, the touch operation region can be easily determined without having to trouble the user. In addition, the user operation input to the touch panel display of the information processing device can be easily transformed as the control instruction to the portable terminal.

Moreover, according to Embodiment 1, by using the fact that the output screen information to which a black belt region is added in accordance with the resolution that is compatible by both the in-car device 1 and the portable terminal 2 is input to the side of the in-car device 1, the operation region acquisition unit 14 has been configured so that it can acquire the binarization image by performing binarization processing to the output screen information, detect the screen information and the boundary of the black belt region, and identify the touch operation region, and the touch operation region can thereby be easily determined.

Moreover, according to Embodiment 1, the configuration is such that when the communication of the in-car device 1 and the portable terminal 2 is established, the output screen of the portable terminal 2 is displayed on the display screen of the touch panel display 13 of the in-car device 1 to identify the touch operation region, and the calibration processing of acquiring the operation region information is performed; thus, the calibration processing can be performed with the establishment of the communication as the trigger, and there is an advantage in that the user's intentional calibration operation is not required. Moreover, the calibration processing can be automatically performed before performing the operation of controlling the application of the portable terminal.

Moreover, according to Embodiment 1, the configuration is such that when the in-car device 1 is activated, a communicable portable terminal 2 is searched, and when a communicable portable terminal 2 is detected, the communication connection with the portable terminal 2 is started and calibration processing is performed; thus, the calibration processing can be immediately executed by the user getting into the vehicle without having to perform the connection setting of either the in-car device or the portable terminal, and the remote operation of the portable terminal via the in-car device can thereby be executed.

Note that the other configuration of the information processing system shown in FIG. 7 is not limited to Embodiment 1, and may also be applied to Embodiment 2 to Embodiment 6 explained later.

### Embodiment 2

Embodiment 2 explains a configuration of displaying a calibration screen on the output screen of the portable terminal 2 and the touch panel display 13 of the in-car device 1 based on the calibration request that is output from the in-car device 1.

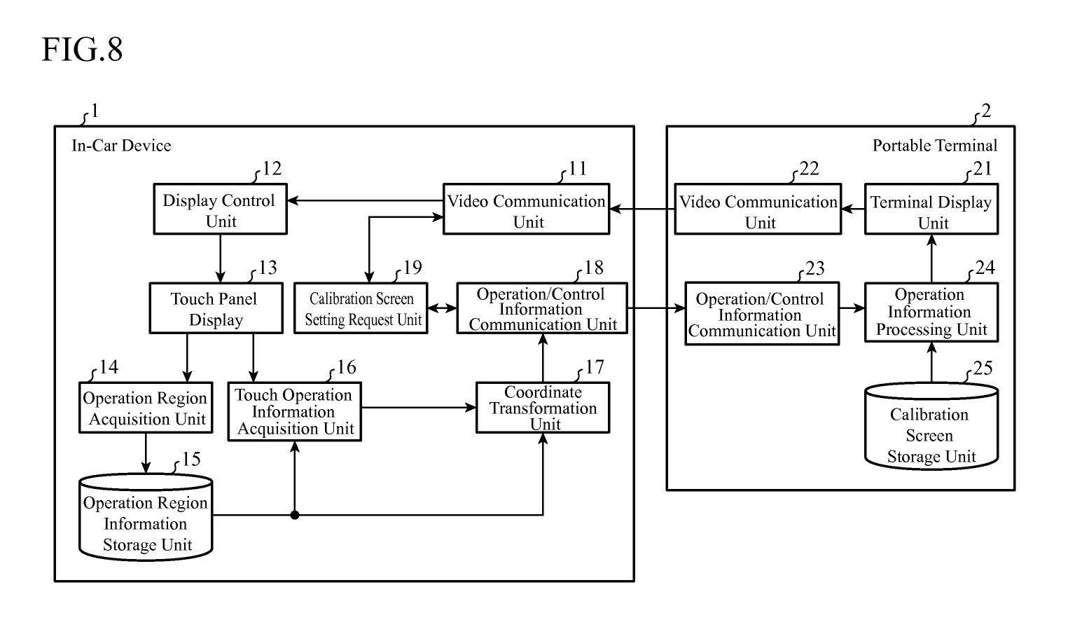

FIG. 8 is a block diagram showing a configuration of an information processing system according to Embodiment 2 of the present invention. A calibration screen setting request unit 19 has been additionally provided to the in-car device 1 and a calibration screen storage unit 25 has been additionally provided to the portable terminal 2 of the information processing system of Embodiment 1 illustrated in FIG. 1. Note that, in the following, components that are the same as or correspond to the constituent elements of the information processing system according to Embodiment 1 are denoted by the same reference numerals as those used in Embodiment 1, and explanations thereof are omitted or simplified.

The calibration screen setting request unit 19 provided to the in-car device 1 monitors a communicably connected state of the in-car device 1 to the portable terminal 2; that is, the communicably connected state of the video communication unit 11 and the operation/control information communication unit 18, and outputs a calibration screen setting request to the portable terminal 2 when the communication connection is established. Here, the term “calibration screen setting request” refers to the request for displaying a special calibration screen to be referred to upon performing the calibration processing explained in Embodiment 1. The output calibration screen setting request is input to the side of the portable terminal 2 via the operation/control information communication unit 18 of the in-car device 1. On the side of the portable terminal 2, the operation information processing unit 24 reads the calibration screen stored in the calibration screen storage unit 25 according to the input calibration screen setting request, and performs control for displaying the calibration screen on the terminal display unit 21.

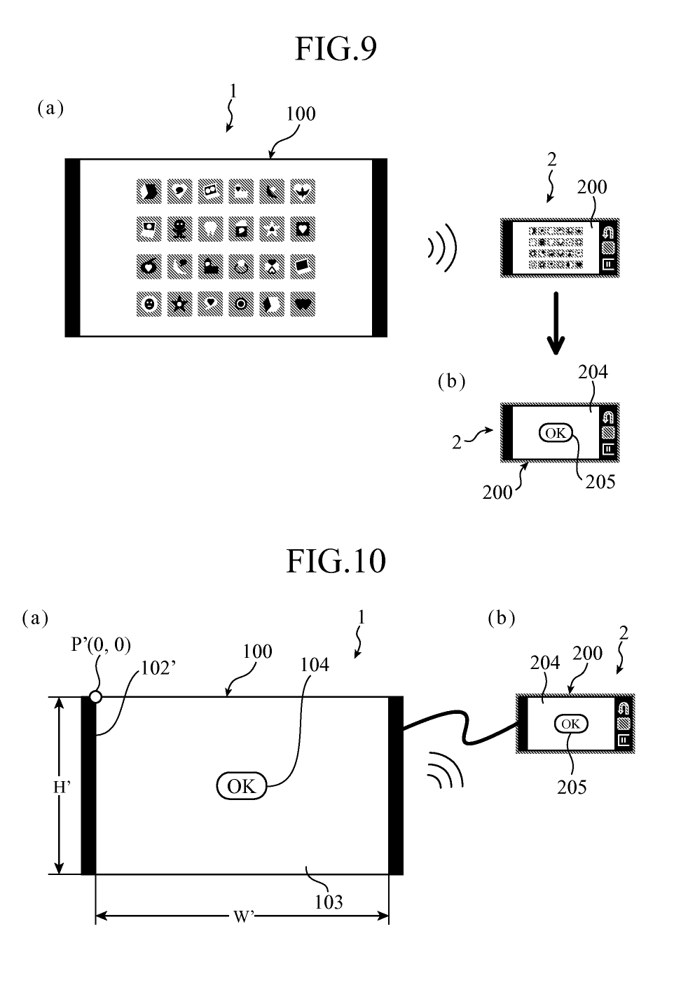

An example of the processing of displaying the calibration screen on the display screen of the portable terminal 2 and the calibration processing using the calibration screen are now explained with reference to FIG. 9 and FIG. 10.

In a state where the communication of the in-car device 1 and the portable terminal 2 is established via Bluetooth, as shown in FIG. 9(a), a screen 200 is displayed on the portable terminal 2, and a portable terminal output screen 100 is displayed on the touch panel display 13 of the in-car device 1. In this display state, when the calibration screen setting request unit 19 of the in-car device 1 outputs a calibration screen setting request to the side of the portable terminal 2, the operation information processing unit 24 of the portable terminal 2 reads the calibration screen from the calibration screen storage unit 25, and displays the calibration screen on the terminal display unit 21 (refer to FIG. 9(b)). The calibration screen is configured by disposing a background 204 and a button 205 on the screen 200. The region outside the operation screen display region which is a black belt region is added to the screen 200 shown in FIG. 9(b), and sent as the output screen information to the side of the in-car device 1.

An example where the output screen information is displayed on the touch panel display 13 of the in-car device 1 and configures the portable terminal output screen 100 is shown in FIG. 10(a). The portable terminal output screen 100 is configured from a touch operation region 103 showing the operation screen display region which configures the screen 200, and a region 102′ outside the touch operation region which displays the added region outside the operation screen display region as the black belt region. As shown in FIG. 10(a), the touch operation region 103 displays a background that is configured from a color such as white that will have a clear contrast to the black belt region, and a button 104 at the center for confirming the calibration processing.

As with Embodiment 1, the operation region acquisition unit 14 performs binarization processing to the portable terminal output screen 100, and acquires a binarization image. Based on the acquired binarization image, a boundary between the region outside the touch operation region 102′ and the touch operation region 103 is detected, and the touch operation region 103 is identified based on the detected boundary. Moreover, a starting point position P′ (0, 0) of the identified touch operation region 103, and size information represented with a horizontal width W′ and a vertical height H′ of the touch operation region 103 are acquired. The acquired starting point P′ and size information of the touch operation region 103 are stored in the operation region information storage unit 15 as the operation region information.

When the user operation of pressing the button 104 that becomes active based on the acquisition of the operation region information is input, the same coordinate transformation processing as Embodiment 1 is performed in response to the user operation to acquire the operation information. The acquired operation information is output to the side of the portable terminal 2. The operation information processing unit 24 of the portable terminal 2 performs control of pressing the button 205 in the background 204 based on the input operation information. In other words, the button 205 displayed on the terminal display unit 21 of the portable terminal 2 is intermittently pressed based on the operation input to the touch panel display 13 of the in-car device 1, and the end of the calibration processing is thereby confirmed, and the normal screen shown in FIG. 9(a) is displayed.

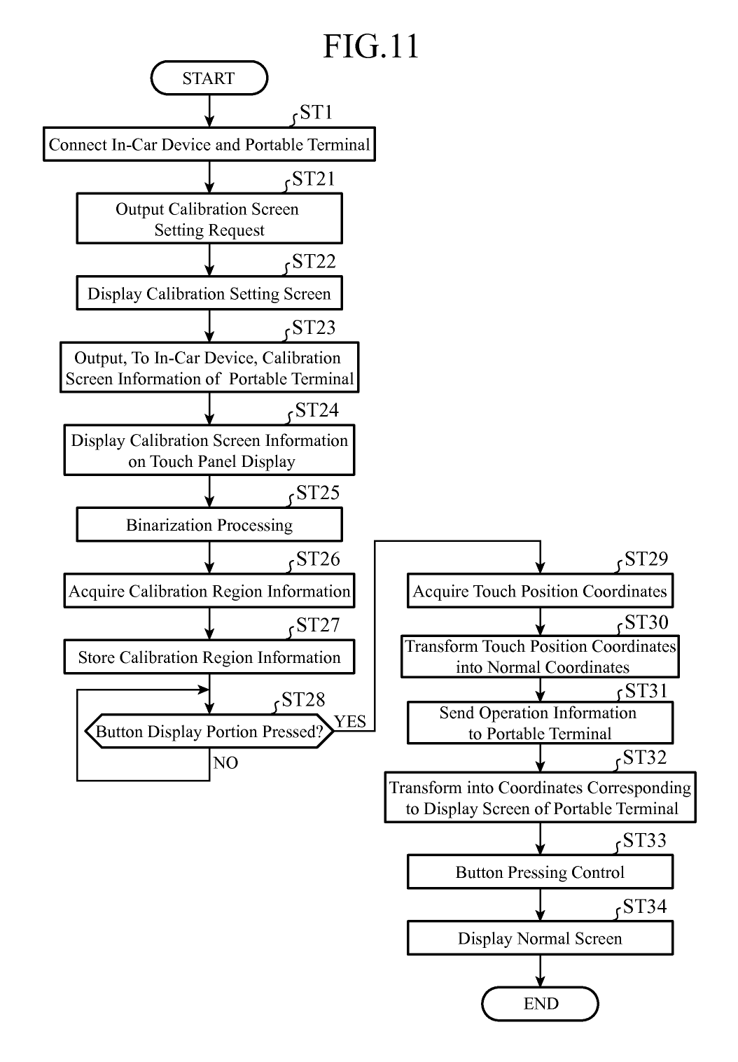

The calibration processing of the information processing system of Embodiment 2 is now explained with reference to the flowchart of FIG. 11. Note that, in the following, the same steps as those of the information processing system according to Embodiment 1 are denoted by the same reference numerals as those used in FIG. 5, and explanations thereof are omitted or simplified.

The in-car device 1 and the portable terminal 2 are connected via HDMI and Bluetooth (refer to step ST1, FIG. 9(a)). The calibration screen setting request unit 19 of the in-car device 1 outputs the calibration screen setting request to the portable terminal 2 via the operation/control information communication unit 18 (step ST21). The portable terminal 2 receives the calibration screen setting request output in step ST21 with the operation information processing unit 24 via the operation/control information communication unit 23, reads the calibration screen from the calibration screen storage unit 25, and displays the read calibration screen on the terminal display unit 21 (refer to step ST22, FIG. 9(b)).

The video communication unit 22 of the portable terminal 2 outputs to the side of the in-car device 1 the calibration screen information of the terminal display unit 21 displayed in step ST22 (step ST23). The in-car device 1 receives the calibration screen information output in step ST23 with the display control unit 12 via the video communication unit 11, and displays the received calibration screen information on the display screen of the touch panel display 13 (refer to step ST24, FIG. 10(a)). The operation region acquisition unit 14 performs binarization processing to the calibration screen information displayed on the display screen of the touch panel display 13, and detects the boundary between the operation screen display region and the region outside the operation screen display region from the acquired binarization image (step ST25). The operation region acquisition unit 14 identifies the operation screen display region based on the detected boundary, and acquires the starting point position and size information of the identified operation screen display region (step ST26). The acquired starting point position and size information are stored as calibration region information in the operation region information storage unit 15 (step ST27).

When the calibration region information is acquired, the sending of the touch operation information becomes active, and the processing enters an input waiting state of waiting for the input of a user's operation (step ST28). The touch operation information acquisition unit 16 monitors the touch state of the touch panel display 13 and, when the button display portion has not been pressed (step ST28; NO), returns to the input waiting state of step ST28. Meanwhile, when the button display portion has been pressed (step ST28; YES), the touch operation information acquisition unit 16 refers to the operation region information stored in step ST27, and acquires a touch position coordinate corresponding to the button pressing operation (step ST29). The coordinate transformation unit 17 refers to the operation region information stored in step ST27, performs normal coordinate transformation to the touch position coordinate acquired in step ST29, and thereby acquires a normal coordinate (step ST30).

The operation/control information communication unit 18 sends the normal coordinate acquired in step ST30 as the operation information to the side of the portable terminal 2 (step ST31). The operation information processing unit 24 of the portable terminal 2 acquires the operation information acquired in step ST31 via the operation/control information communication unit 23 of the portable terminal 2, and transforms the normal coordinate corresponding to the operation input which is the operation information into the coordinate corresponding to the display screen of the terminal display unit 21 (step ST32). In addition, the operation information processing unit 24 performs control of pressing the button displayed on the display screen based on the coordinate value of the coordinate transformed in step ST32 (refer to step ST33, FIG. 10(b)). When the processing of step ST33 is performed, the operation information processing unit 24 determines that the calibration has been normally performed and displays a normal screen on the terminal display unit 21 (step ST34), and ends the calibration processing.

As described above, according to Embodiment 2, the portable terminal 2 comprises the calibration screen storage unit 25 that stores the calibration screen, and the in-car device 1 comprises the calibration screen setting request unit 19 that outputs the calibration screen setting request to the portable terminal 2, and the configuration is such that the operation region acquisition unit 14 refers to the calibration screen displayed on the display screen of the touch panel display 13 of the in-car device 1, and thereby acquires the touch operation region; thus, the difference between the operation screen display region and the region other than the operation screen display region becomes clear, and the touch operation region can be easily and accurately identified.

Consequently, for example, even in cases where an application having a screen background that is close to a black color is running on the portable terminal 2, a calibration screen that will clearly be different from the black belt region is displayed, and the touch operation region can thereby be identified accurately and easily. In other words, even in cases where it is difficult for the in-car device 1 to identify the operation screen display region and the region other than the operation screen display region, the touch operation region can be easily and accurately identified.

Moreover, according to Embodiment 2, the following configuration is provided: the button that can be pressed after acquiring the operation region information is provided to the calibration screen displayed on the display screen of the portable terminal 2, the pressing operation of the button display position input via the touch panel display 13 of the in-car device 1 is transformed into the pressing operation of the button of the portable terminal 2, and the button of the portable terminal 2 can thereby be pressed indirectly; thus, the portable terminal 2 can confirm whether the calibration processing has been accurately executed.

### Embodiment 3

Embodiment 3 explains a configuration of performing the calibration processing on the side of the in-car device in consideration of whether the screen direction of the portable terminal has been changed.

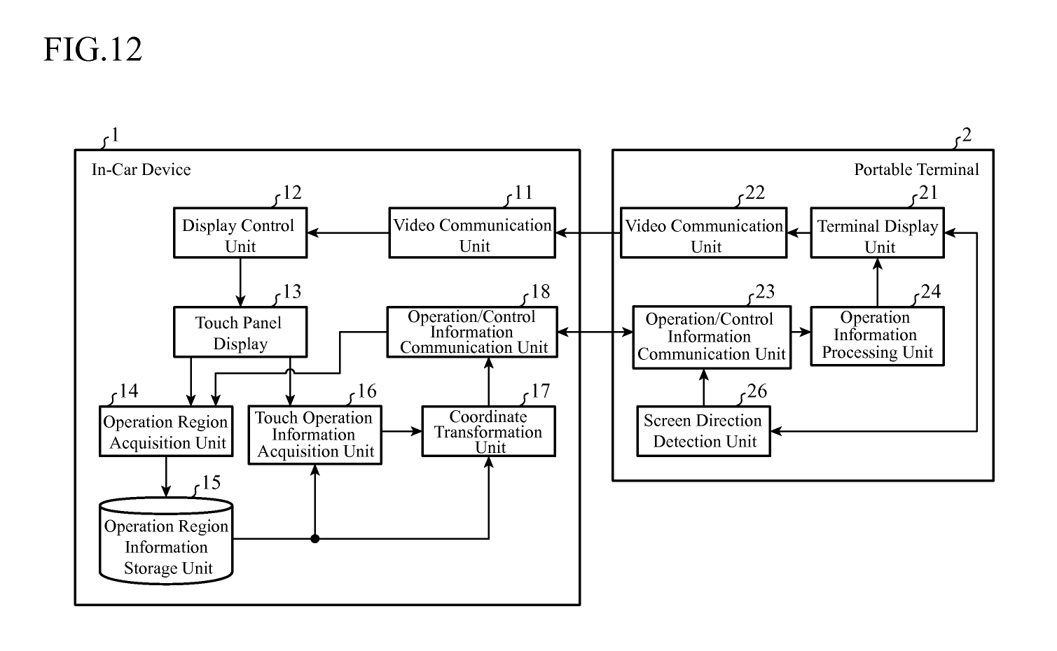

FIG. 12 is a block diagram showing a configuration of an information processing system according to Embodiment 3 of the present invention. A screen direction detection unit 26 has been additionally provided to the portable terminal 2 of the information processing system of Embodiment 1 shown in FIG. 1. Note that, in the following, components that are the same as or correspond to the constituent elements of the information processing system according to Embodiment 1 are denoted by the same reference numerals as those used in Embodiment 1, and explanations thereof are omitted or simplified.

The screen direction detection unit 26 is configured from a sensor or the like that detects the direction or rotation of the terminal display unit 21 of the portable terminal 2. Moreover, the screen direction detection unit 26 may also be a unit that detects the direction or rotation of the terminal display unit 21 based on the direction or rotation of the portable terminal 2 itself. Specifically, the screen direction detection unit 26 is configured by comprising at least one mechanism among the direction detecting mechanism of an accelerator sensor (gravity sensor) that detects the direction of the terminal display unit 21 or the portable terminal 2, or a rotation detection mechanism that detects the rotation of the terminal display unit 21 or the portable terminal 2. When detecting that the direction of the terminal display unit 21 has been changed by referring to the detection result, the screen direction detection unit 26 outputs a re-acquisition request of the touch operation region to the side of the in-car device 1 via the operation/control information communication unit 23 of the portable terminal 2.

The re-acquisition request that is input to the side of the in-car device 1 is input to the operation region acquisition unit 14 via the operation/control information communication unit 18, and the operation region acquisition unit 14 performs image analysis to the portable terminal output screen that is currently being displayed on the touch panel display 13 based on the input re-acquisition request, thereby determines the touch operation region, and acquires the operation region information of the determined touch operation region. The acquired operation region information is stored in the operation region information storage unit 15.

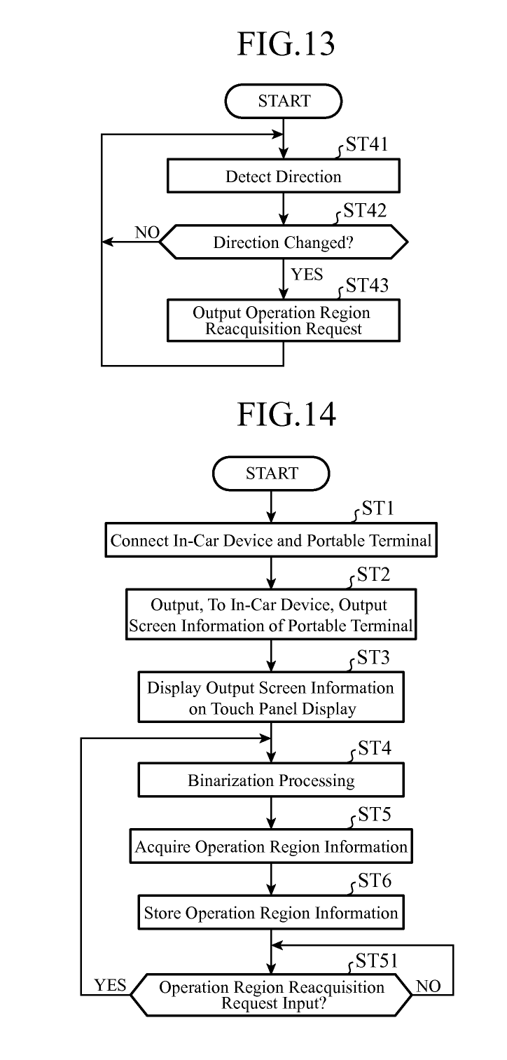

The calibration processing of the information processing system according to Embodiment 3 is now explained with reference to FIG. 13 and FIG. 14.

The operation of the portable terminal 2 is foremost explained.

FIG. 13 is a flowchart showing the screen direction detection processing of the information processing system according to Embodiment 3 of the present invention. Note that, in the flowchart of FIG. 13, explained is a case of the screen direction detection unit 26 detecting the direction and rotation of the terminal display unit 21.

In a state where the in-car device 1 and the portable terminal 2 are connected via HDMI and Bluetooth, the screen direction detection unit 26 of the portable terminal 2 acquires the direction of the terminal display unit 21 (step ST41), and determines whether the direction of the terminal display unit 21 has been changed from the previous detection result (step ST42). When the direction of the terminal display unit 21 has not been changed (step ST42; NO), the routine returns to the processing of step ST41, and the foregoing processing is repeated. Meanwhile, when the direction of the terminal display unit 21 has been changed (step ST42; YES), the screen direction detection unit 26 outputs the re-acquisition request of the touch operation region to the side of the in-car device 1 (step ST43). Subsequently, the routine returns to the processing of step ST41, and the foregoing processing is repeated.

The operation of the in-car device 1 is now explained.

FIG. 14 is a flowchart showing calibration processing of the in-car device of the information processing system according to Embodiment 3 of the present invention.

Note that, with the calibration processing in the in-car device 1, the same steps as those of the calibration processing shown in FIG. 5 are denoted by the same reference numerals as those used in FIG. 5, and explanations thereof are omitted or simplified.

When the in-car device 1 and the portable terminal 2 are connected via HDMI and Bluetooth in step ST1, the in-car device 1 performs the same processing from step ST2 to step ST6 to acquire and store the operation region information. In addition, the operation region acquisition unit 14 determines whether the re-acquisition request of the touch operation region has been input from the side of the portable terminal 2 (step ST51).

When a re-acquisition request of the touch operation region has been input (step ST51; YES), the routine returns to the processing of step ST4, performs binarization processing to the image that is currently being displayed on the touch panel display 13, and performs the processing of step ST5 and step ST6. Meanwhile, when the re-acquisition request of the touch operation region has not been input (step ST51; NO), the routine returns to the determination processing of step ST51, and waits.

Note that, let it be assumed that the output screen information of the portable terminal 2 is constantly being updated, and that the screen information of the portable terminal 2 is displayed in real-time on the touch panel display 13 of the in-car device 1 based on the processing of step ST2 and step ST3 of the flowchart of FIG. 14.

As described above, according to Embodiment 3, when the change in the direction of the terminal display unit 21 of the portable terminal 2 is detected, the in-car device 1 is configured to comprise the screen direction detection unit 26 that outputs the re-acquisition request of the touch operation region and an operation region acquisition unit 14 that reacquires the touch operation region of the portable terminal output screen displayed on the touch panel display 13 based on the re-acquisition request of the touch operation region; thus, even when the portable terminal in which the screen direction can be changed is connected, the touch operation region can be reacquired according to the screen direction. It is thereby possible to reacquire the touch operation region according to the screen direction even with respect to an application in which the change in the screen direction is desirable, and it is possible to build a highly versatile information processing system.

### Embodiment 4

Embodiment 4 explains a configuration of setting the touch operation region based on the user's operation input.

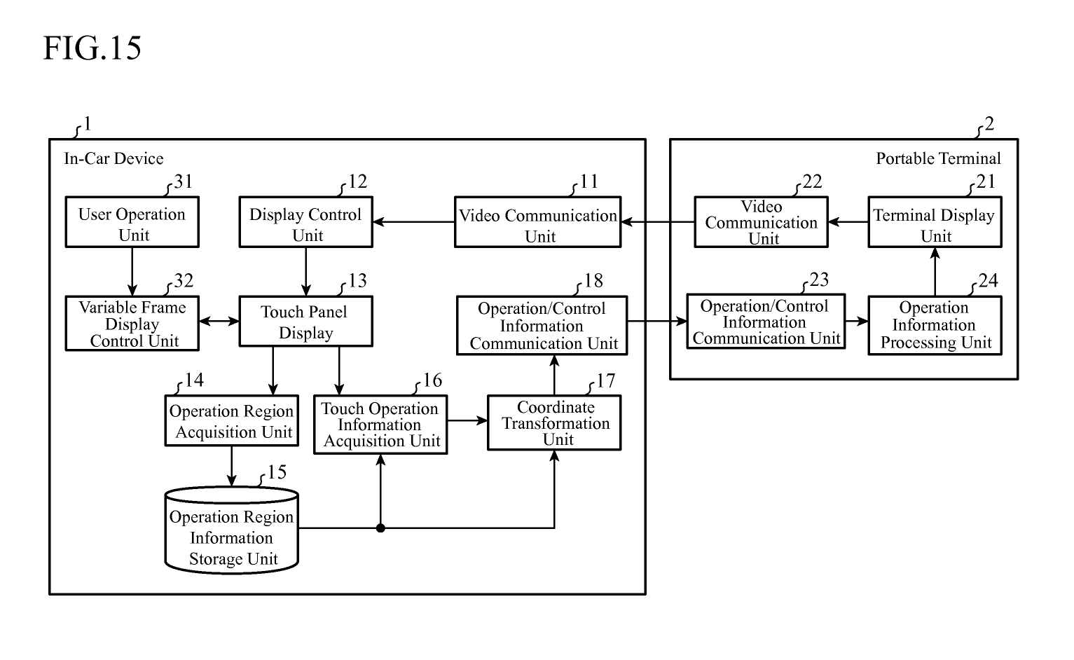

FIG. 15 is a block diagram showing a configuration of an information processing system according to Embodiment 4 of the present invention. A user operation unit 31 and a variable frame display control unit 32 have been additionally provided to the in-car device 1 of the information processing system of Embodiment 1 shown in FIG. 1. Note that, in the following, components that are the same as or correspond to the constituent elements of the information processing system according to Embodiment 1 are denoted by the same reference numerals as those used in Embodiment 1, and explanations thereof are omitted or simplified.

The user operation unit 31 is configured from a user interface such as a GUI that operates a variable frame displayed on the touch panel display 13 and sets the region within the variable frame as the operation region, and a remote control button that remotely operates the variable frame displayed on the touch panel display 13, and sets the region within the variable frame as the operation region. The variable frame display control unit 32 displays on the touch panel display 13 the variable frame that can be operated with the user operation unit 31. Moreover, it performs the display control of enlarging/reducing the variable frame by following the user's operation that is input via the user operation unit 31. Moreover, it sets the inside of the variable frame as the touch operation region by performing the setting operation of the operation region.

The operation region acquisition unit 14 sets the touch operation region inside and outside the variable frame displayed by the variable frame display control unit 32 based on the setting operation of the user operation unit 31, and thereby acquires the operation region information.

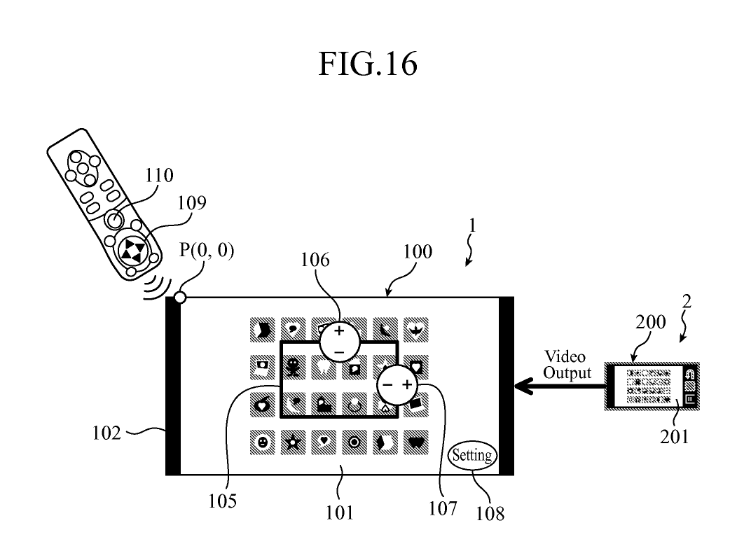

FIG. 16 is a diagram showing a display example of the information processing system according to Embodiment 4 of the present invention.

As with Embodiment 1 described above, the screen 200 of the portable terminal 2 is configured from the operation screen display region 201, and the touch panel display 13 of the in-car device 1 is configured from the portable terminal output screen 100. The variable frame display control unit 32 superimposes and displays the variable frame 105 on the portable terminal output screen 100 in order to set the touch operation region 101. By operating the user operation unit 31, the user can enlarge or reduce the variable frame 105, visually cause the boundary between the touch operation region 101 and the region outside the touch operation region 102 to coincide with the variable frame 105, and, with the region within the variable frame 105 as the touch operation region, acquire the starting point position P, and the size information indicating the horizontal width W and the vertical height H of the touch operation region.

As the means for enlarging or reducing the variable frame 105, in FIG. 16, illustrated are a GUI 106 that moves the long side of the variable frame 105, and a GUI 107 that moves the short side of the variable frame 105. By selecting the “+” region of the GUI 106 and the GUI 107, the variable frame 105 is enlarged with the center point (not shown) in the frame as a base point, and by selecting the “−” region, the variable frame 105 is reduced with the center point in the frame as the base point. By pressing the GUI 108 representing a setting button at the lower right of the screen, the inside of the variable frame can be set as the operation region. Moreover, in FIG. 16, additionally shown are an arrow key of the remote control button 109 that enlarges or reduces the variable frame 105, and a setting button 110 that sets the variable frame as the operation region.

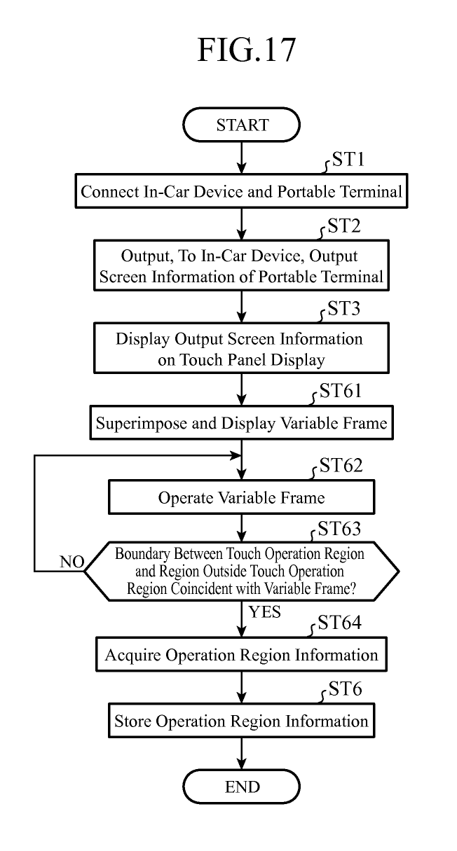

The calibration processing of the information processing system of Embodiment 4 is now explained with reference to the flowchart of FIG. 17. Note that the same steps as those of the information processing system according to Embodiment 1 are denoted by the same reference numerals as those used in FIG. 5, and explanations thereof are omitted or simplified.

The in-car device 1 and the portable terminal 2 are connected via HDMI and Bluetooth (step ST1). The video communication unit 22 of the portable terminal 2 output to the side of the in-car device 1 the output screen information of the terminal display unit 21 via HDMI (step ST2). The in-car device 1 receives the output screen information output in step ST2 with the display control unit 12 via the video communication unit 11, and displays the received output screen information on the display screen of the touch panel display 13 (step ST3).

The variable frame display control unit 32 superimposes and displays the variable frame on the touch panel display 13 on which the output screen information is displayed in step ST3 (step ST61). An operation input to the variable frame that is superimposed and displayed in step ST61 is received via the user operation unit 31 (step ST62). The user determines whether the boundary between the touch operation region and the region outside the touch operation region of the portable terminal output screen information is coincident with the variable frame (step ST63). When the boundary between the touch operation region and the region outside the touch operation region is not coincident with the variable frame (step ST63; NO), the routine returns to the processing of step ST62, and continues receiving the operation input to the variable frame. Meanwhile, when it is determined that the boundary between the touch operation region and the region outside the touch operation region is coincident with the variable frame (step ST63; YES), the operation region acquisition unit 14 acquires the starting point position and the size information of the region that is coincident with the variable frame based on the setting operation of the user operation unit 31 (step ST64). The acquired starting point position and size information are stored as the operation region information in the operation region information storage unit 15 (step ST6), and the calibration processing is thereby ended.

As described above, according to Embodiment 4, the following configuration is provided: the variable frame display control unit 32 that superimposes and displays the variable frame on the display screen of the touch panel display 13 of the in-car device 1 on which the screen information of the portable terminal 2 is displayed, and the user operation unit 31 that receives the enlargement/reduction operation of the displayed variable frame are provided, and when the variable frame is coincident with the boundary between the touch operation region and the region outside the touch operation region of the portable terminal output screen, the operation region information is acquired with the coincident region as the touch operation region; thus, the variable frame can be enlarged and reduced based on the touch operation or remote control operation, and the user can set the touch operation region with visual confirmation. It is thereby possible to accurately set the touch operation region with visual confirmation even in cases where the application in which the touch operation region of the portable terminal output screen is close to a black color.

### Embodiment 5

Embodiment 5 explains the configuration for acquiring the operation region information from the outside of the information processing system.

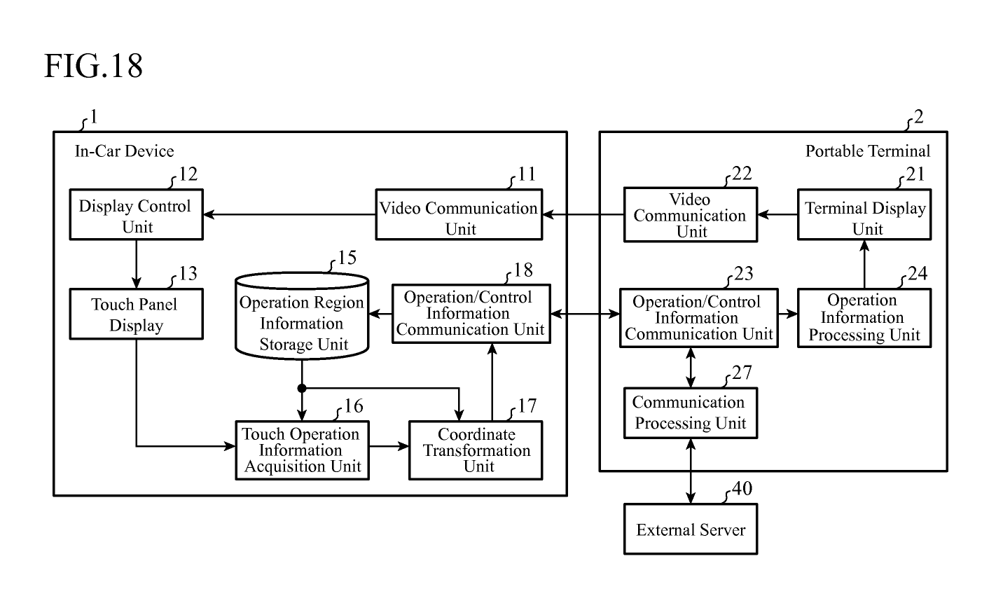

FIG. 18 is a block diagram showing a configuration of an information processing system according to Embodiment 5 of the present invention. In substitute for the operation region acquisition unit 14 provided to the in-car device of the information processing system of Embodiment 1 shown in FIG. 1, the portable terminal 2 comprises a communication processing unit 27 that can be connected to an external server. Note that, in the following, components that are the same as or correspond to the constituent elements of the information processing system according to Embodiment 1 are denoted by the same reference numerals as those used in Embodiment 1, and explanations thereof are omitted or simplified.

An external server 40 is configured from a web service server or the like. Let it be assumed that the external server 40 holds operation region information that is decided based on a combination of respective models of the portable terminal 2 and the in-car device 1, and size information of the display screen that is decided based on the model of the portable terminal 2.

The communication processing unit 27 communicates with the external server 40 based on a communication means such as a wireless LAN or a 3G line and accesses the external server 40, and thereby acquires the operation region information between the mutually communicably connected portable terminal 2 and the in-car device 1, and the size information (horizontal width: Wide[px], vertical height: Height [px]) of the display screen of the portable terminal 2. Here, the term “operation region information” means, as with Embodiment 1, information representing the starting point position and size information of the touch operation region when the portable terminal output screen is displayed on the touch panel display 13. Specifically, by the communication processing unit 27 inputting an identifying ID of the portable terminal 2 and the in-car device 1 to the external server 40, it is possible to acquire the operation region information according to the combination of the portable terminal 2 and the in-car device 1 of the models that are compliant with the identifying ID, and the size information of the display screen of the portable terminal 2 of the model that is compliant with the identifying ID. Let it be assumed that the identifying ID is acquired when the operation/control information communication unit 23 communicates with the operation/control information communication unit 18, and provided to the communication processing unit 27.

The operation region information acquired by the communication processing unit 27 is output to the side of the in-car device 1 via the operation/control information communication unit 23 of the portable terminal 2, and stored in the operation region information storage unit 15 via the operation/control information communication unit 18 of the in-car device 1. The touch operation information acquisition unit 16 and the coordinate transformation unit 17 refer to the operation region information stored in the operation region information storage unit 15 and perform the coordinate transformation processing.

Meanwhile, the size information of the display screen of the portable terminal 2 acquired by the communication processing unit 27 is output to the operation information processing unit 24 via the operation/control information communication unit 23, and stored in a storage region (not shown) or the like. The operation information processing unit 24 acquires the coordinate information from the operation information notified from the side of the in-car device 1, and refers to the stored size information of the display screen upon transforming into the coordinate corresponding to the display screen of the terminal display unit 21.

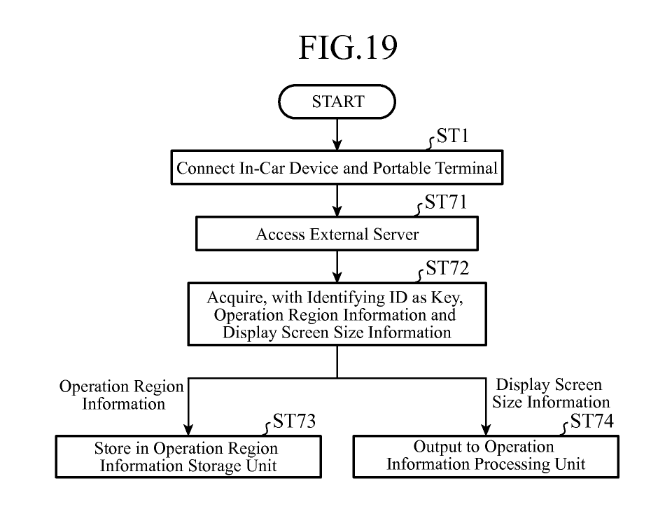

The calibration processing of the information processing system of Embodiment 5 is now explained with reference to the flowchart of FIG. 19. Note that the same steps as those of the information processing system according to Embodiment 1 are denoted by the same reference numerals as those used in FIG. 5, and explanations thereof are omitted or simplified.

The in-car device 1 and the portable terminal 2 are connected via HDMI and Bluetooth (step ST1). The communication processing unit 27 of the portable terminal 2 accesses the external server 40 (step ST71), and acquires the corresponding operation region information and the size information of the display screen of the portable terminal 2 with the identifying ID of the portable terminal 2 and the in-car device 1 as the key (step ST72). The operation region information acquired in step ST72 is output to the side of the in-car device 1, and stored in the operation region information storage unit 15 of the in-car device 1 (step ST73). Meanwhile, the size information of the display screen acquired in step ST72 is output to the operation information processing unit 24 (step ST74), and the processing is thereby ended.

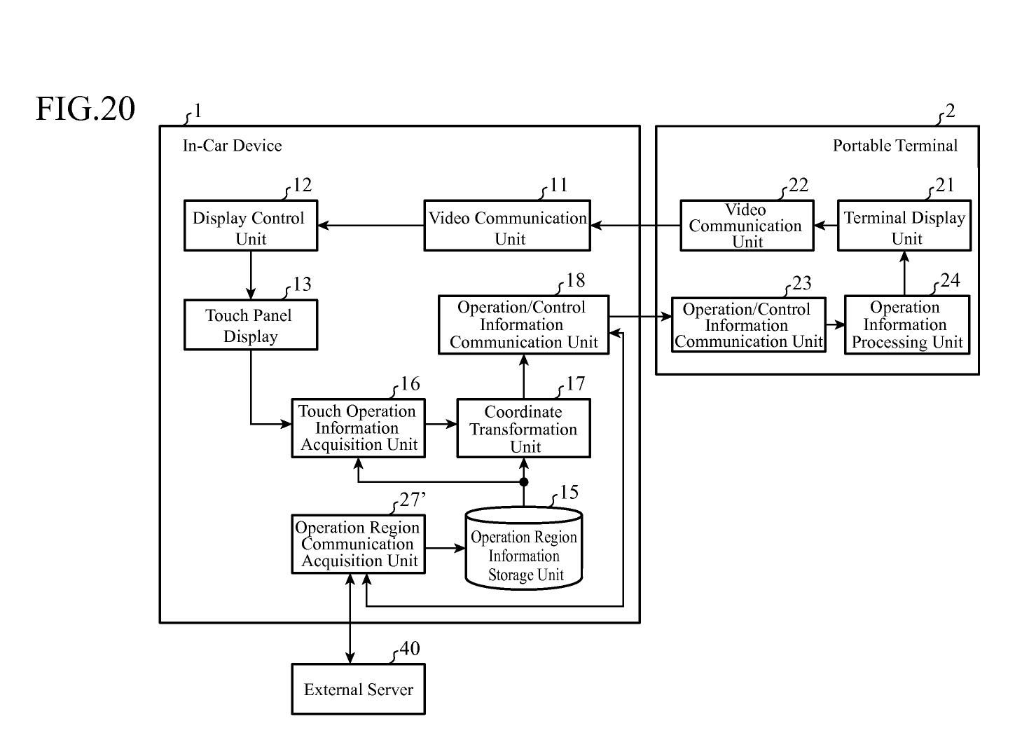

Note that the access to the external server 40 is not limited to the configuration shown in the block diagram of FIG. 18, and the configuration may be as shown in the block diagram of FIG. 20 where the in-car device 1 comprises a communication processing unit 27′ and can access the external server 40.

As described above, according to Embodiment 5, a configuration is adopted to comprise communication processing units 27, 27′ that access the external server 40 and acquire the operation region information corresponding to the portable terminal 2 and the in-car device 1; thus, there is no need to equip the in-car device or the portable terminal with a function with a high calculation load for calculating the operation region information. Consequently, it is possible to acquire accurate operation region information and enable smooth remote operation even between an in-car device and a portable terminal with limited functions.

### Embodiment 6

Embodiment 6 explains a configuration of storing the operation region information acquired by the calibration processing of the in-car device in association with the identifying information of the portable terminal, and utilizing the stored operation region information during the next and later connections of the in-car device and the portable terminal.

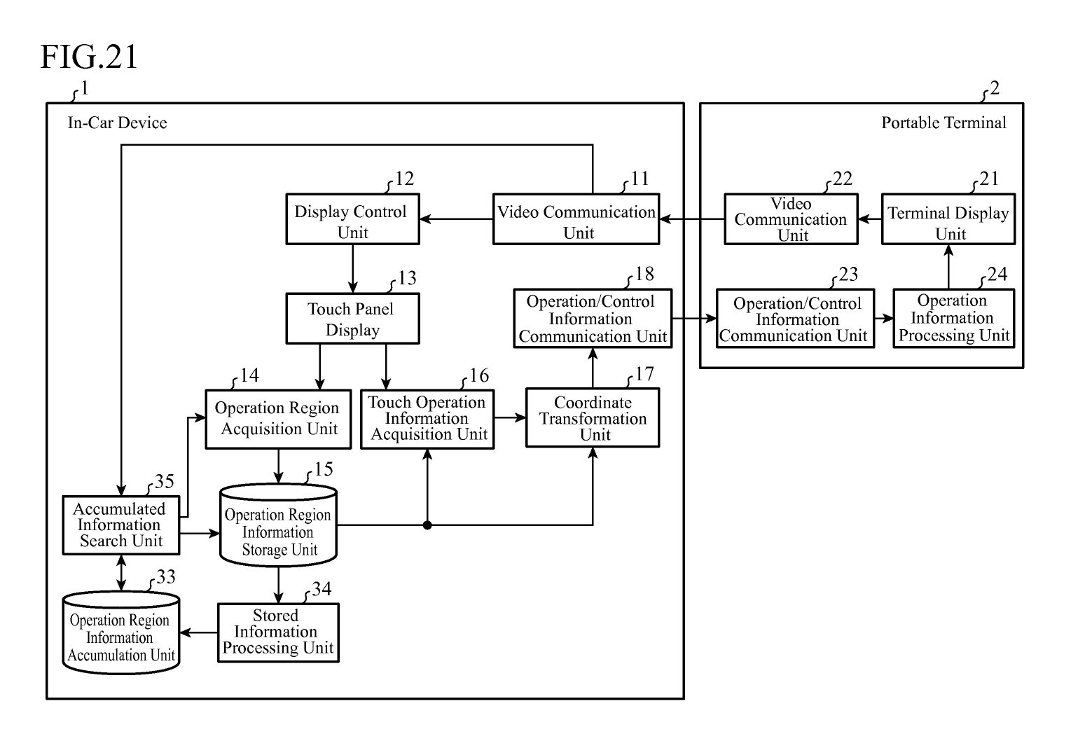

FIG. 21 is a block diagram showing a configuration of an information processing system according to Embodiment 6 of the present invention. An operation region information accumulation unit 33, a stored information processing unit 34 and an accumulated information search unit 35 have been additionally provided to the in-car device 1 of the information processing system of Embodiment 1 shown in FIG. 1. Note that, in the following, components that are the same as or correspond to the constituent elements of the information processing system according to Embodiment 1 are denoted by the same reference numerals as those used in Embodiment 1, and explanations thereof are omitted or simplified.

The operation region acquisition unit 14 associates the acquired operation region information and the identifying name such as the terminal name of the portable terminal 2, and stores the association in the operation region information storage unit 15.

The operation region information storage unit 15 is, for example, a volatile memory configured from a RAM or the like, and temporarily stores the identifying name and the operation region information acquired by the operation region acquisition unit 14.

The operation region information accumulation unit 33 is a nonvolatile memory configured from an SD card or the like, and the operation region information and identifying name stored in the operation region information storage unit 15 are written via the stored information processing unit 34 described later when the power of the in-car device 1 is turned OFF.

When the stored information processing unit 34 detects the power OFF operation of the in-car device 1, the stored information processing unit 34 reads the operation region information and identifying name stored in the operation region information storage unit 15, and performs processing of writing the operation region information and identifying name in the operation region information accumulation unit 33. For example, when a plurality of portable terminals 2 are connected during a period from the activation to the power OFF of the in-car device 1, the operation region information and identifying name of a plurality of portable terminals 2 are written in the operation region information accumulation unit 33 when the power is turned OFF. Note that the timing of writing the operation region information and identifying name into the operation region information accumulation unit 33 may be the one when the power OFF operation of the in-car device 1 is performed, but the configuration may also be such that the operation region acquisition unit 33 writes the operation region information and identifying name upon acquiring the operation region. In the following, the explanation is provided on the assumption that the operation region information and identifying name are written when the power OFF operation of the in-car device 1 is performed.

When the in-car device 1 is activated at the next time, the accumulated information search unit 35 performs a search to check whether the operation region information of the portable terminal 2 connected to that in-car device 1 is accumulated in the operation region information accumulation unit 33. When the operation region information of the connected portable terminal 2 exists, the processing of reading the operation region information and the identifying name of that portable terminal 2, writing the operation region information and the identifying name in the operation region information storage unit 15 is performed. Moreover, in addition to the next-time activation of the in-car device 1, the operation region information accumulation unit 33 also performs the search when a new portable terminal 2 is connected, and the processing of reading the corresponding operation region information and identifying name, and writing the read corresponding operation region information and identifying name in the operation region information storage unit 15 is performed.

Note that the determination of whether a new portable terminal 2 has been connected at the next-time time or during the activation and the acquisition of the identifying name of the connected terminal are performed by referring to the information input from the video communication unit 11.

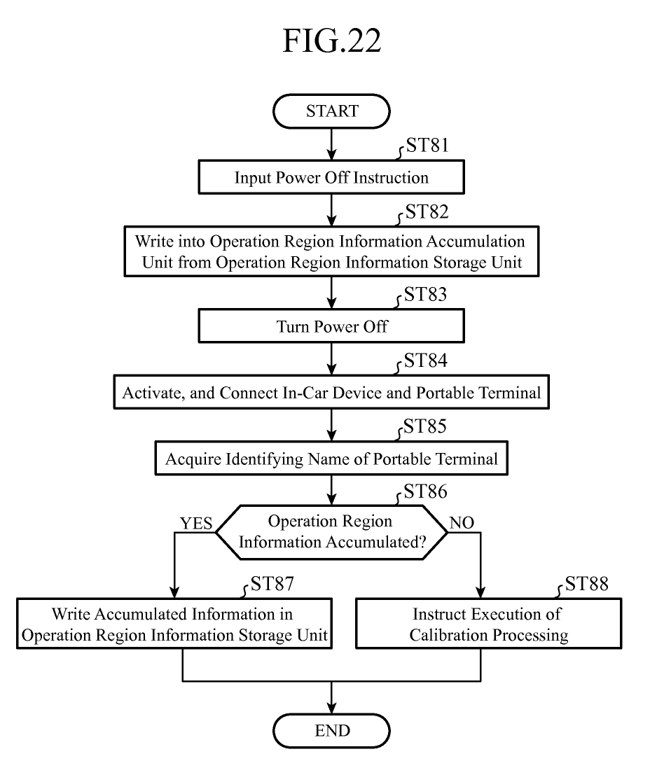

An operation of the information processing system of Embodiment 6 is now explained with reference to a flowchart of FIG. 22.

FIG. 22 is the flowchart showing the accumulation and search processing of the operation region information of the information processing system according to Embodiment 6 of the present invention.

When a power OFF instruction is input to the in-car device 1 (step ST81), the stored information processing unit 34 reads the operation region information and identifying name stored in the operation region information storage unit 15, and writes the read operation region information and identifying name in the operation region information accumulation unit 33 (step ST82). Subsequently, the power of the in-car device 1 is turned OFF (step ST83).

Subsequently, when the in-car device 1 is activated and the in-car device 1 and the portable terminal 2 are connected (step ST84), the accumulated information search unit 35 acquires the identifying name of the portable terminal 2 connected in step ST84 (step ST85). The accumulated information search unit 35 searches for the accumulated data of the operation region information accumulation unit 33, and determines whether the operation region information corresponding to the identifying name acquired in step ST85 has been accumulated (step ST86). When the operation region information has been accumulated (step ST86; YES), the accumulated information search unit 35 reads the corresponding operation region information and identifying name from the operation region information accumulation unit 33, and writes the read corresponding operation region information and identifying name in the operation region information storage unit 15 (step ST87), and thereby ends the processing. Meanwhile, when the operation region information has not been accumulated (step ST86; NO), the accumulated information search unit 35 instructs the operation region acquisition unit 14 to execute the calibration processing (step ST88), and then ends the processing.

The operation region acquisition unit 14 that is instructed to execute the calibration processing in step ST88 performs the calibration processing explained in Embodiment 1 (refer to flowchart of FIG. 5).

Note that, in the foregoing flowchart, explained is a configuration of acquiring the identifying name of the portable terminal 2 that is connected upon the activation of the in-car device 1, but without limitation to the foregoing timing, it is also possible to adopt a configuration of constantly monitoring the communication state between the in-car device 1 and the portable terminal 2, and performing the processing of step ST86 onward when a new portable terminal 2 is connected.

As described above, according to Embodiment 6, the configuration is additionally provided with the stored information processing unit 34 that writes the operation region information stored in the operation region information storage unit 15 into the operation region information accumulation unit 33 as the nonvolatile memory when the power of the in-car device 1 is turned OFF, and the accumulated information search unit 35 that performs the search for checking whether the operation region information corresponding to the portable terminal 2 connected in the next-time activation has been accumulated in the operation region information accumulation unit 33, it is possible to omit the calibration processing to the portable terminal that has previously acquired the operation region information. Moreover, whether to perform the calibration processing can be determined on the side of the in-car device 1, and it is possible to build a highly versatile information processing system without depending on the function of the portable terminal 2.

Note that foregoing Embodiment 2 illustrated an example of adding a configuration to Embodiment 1, and this can also be applied to Embodiments 3 to 6. Moreover, the same applies to Embodiment 3 to Embodiment 6. As described above, with the present invention, the respective embodiments may be freely combined, or arbitrary constituent elements of the respective embodiments may be modified, or arbitrary constituent elements in the respective embodiments may be omitted within the scope of the present invention.

### INDUSTRIAL APPLICABILITY

As described above, the information processing system according to the present invention enables the calibration processing of easily and accurately acquiring the touch operation region of the display screen of one of the communicably connected devices on the side of the other device, and is suitable as an information processing system that performs remote operations between devices having different resolutions and aspect ratios.

### DESCRIPTION OF REFERENCE NUMERALS and SIGNS

1: in-car device

2: portable terminal

11, 22: video communication unit

12: display control unit

13: touch panel display

14: operation region acquisition unit

15: operation region information storage unit

16: touch operation information acquisition unit

17: coordinate transformation unit

18, 23: operation/control information communication unit

19: calibration screen setting request unit

21: terminal display unit

24: operation information processing unit

25: calibration screen storage unit

26: screen direction detection unit

27, 27′: communication processing unit

31: user operation unit

32: variable frame display control unit

33: operation region information accumulation unit

34: stored information processing unit

35: accumulated information search unit

40: external server

100: portable terminal output screen

101, 103: touch operation region

102, 102′: region outside the touch operation region

104: button

105: variable frame

106, 107, 108: GUI

109: remote control button

110: setting button

200: screen

201: operation screen display region

202: region outside the operation screen display region

203: output screen information

204: background

205: button.

1-15. (canceled)

16. An information processing device that includes a communicator communicably connected to an information terminal, and a display provided with a touch panel, that transforms a touch operation performed to the touch panel into remote operation information, and that remotely operates the information terminal by causing the communicator to send the remote operation information to the information terminal, the information processing device comprising:
a display controller that displays a screen of the information terminal on the display by using screen information of the information terminal received from the communicator;
an operation region acquisition unit that performs image analysis to a screen of the display on which the screen of the information terminal is displayed, and acquires operation region information for identifying a touch operation region corresponding to the screen of the information terminal;
a touch operation acquisition unit that detects the touch operation performed to the touch panel, and acquires position information of the detected touch operation based on the operation region information; and
a touch coordinate transformer that transforms, based on the operation region information, the position information of the touch operation acquired by the touch operation acquisition unit into position information corresponding to the screen of the information terminal,
wherein the communicator sends the position information transformed by the touch coordinate transformer to the information terminal as the remote operation information,
the display controller acquires screen information of the information terminal on which a calibration screen is displayed, the calibration screen being configured from an operation screen display region on which a screen to be operated is displayed, and a region outside the operation screen display region and adjacent to the operation screen display region, and displays the calibration screen of the information terminal on the display, and
the operation region acquisition unit performs image analysis to the calibration screen displayed on the display, identifies a boundary between the operation screen display region and the region outside the operation screen display region, and acquires, as the operation region information, a starting point position and a region size of a touch operation region corresponding to the operation screen display region.

17. An information processing device that includes a communicator communicably connected to an information terminal, and a display provided with a touch panel, that transforms a touch operation performed to the touch panel into remote operation information, and that remotely operates the information terminal by causing the communicator to send the remote operation information to the information terminal, the information processing device comprising:
a display controller that displays a screen of the information terminal on the display by using screen information of the information terminal received from the communicator;
an operation region acquisition unit that performs image analysis to a screen of the display on which the screen of the information terminal is displayed, and acquires operation region information for identifying a touch operation region corresponding to the screen of the information terminal;
a touch operation acquisition unit that detects the touch operation performed to the touch panel, and acquires position information of the detected touch operation based on the operation region information; and
a touch coordinate transformer that transforms, based on the operation region information, the position information of the touch operation acquired by the touch operation acquisition unit into position information corresponding to the screen of the information terminal,
wherein the communicator sends the position information transformed by the touch coordinate transformer to the information terminal as the remote operation information,
the display controller acquires screen information of the information terminal on which the screen of the information terminal is displayed, the screen being configured from an operation screen display region on which a screen to be operated is displayed, and a region outside the operation screen display region and adjacent to the operation screen display region, and displays the screen of the information terminal on the display, and
the operation region acquisition unit performs binarization processing to a pixel value in the screen displayed on the display, thereafter identifies a boundary between the operation screen display region and the region outside the operation screen display region, and acquires, as the operation region information, a starting point position and a region size of a touch operation region corresponding to the operation screen display region.

18. The information processing device according to claim 16, wherein
the operation region acquisition unit performs binarization processing to a pixel value in the screen displayed on the display, and thereafter identifies a boundary between the operation screen display region and the region outside the operation screen display region.

19. The information processing device according to claim 16, further comprising:
a calibration screen setting requester that requests the information terminal to display the calibration screen.

20. The information processing device according to claim 17, further comprising:
a variable frame display controller that superimposes and displays a variable frame capable of changing a frame size according to a user operation on the screen of the display on which the screen of the information terminal is displayed, and
the operation region acquisition unit enables a user to designate the boundary between the operation screen display region and the region outside the operation screen display region by using the variable frame that is superimposed and displayed so as to be coincident with the boundary between the operation screen display region and the region outside the operation screen display region.

21. An information processing device that includes a communicator communicably connected to an information terminal, and a display provided with a touch panel, that transforms a touch operation performed to the touch panel into remote operation information, and that remotely operates the information terminal by causing the communicator to send the remote operation information to the information terminal, the information processing device comprising:
a display controller that displays a screen of the information terminal on the display by using screen information of the information terminal received from the communicator;
an operation region acquisition unit that performs image analysis to a screen of the display on which the screen of the information terminal is displayed, and acquires operation region information for identifying a touch operation region corresponding to the screen of the information terminal;
a touch operation acquisition unit that detects the touch operation performed to the touch panel, and acquires position information of the detected touch operation based on the operation region information; and
a touch coordinate transformer that transforms, based on the operation region information, the position information of the touch operation acquired by the touch operation acquisition unit into position information corresponding to the screen of the information terminal,
wherein the communicator sends the position information transformed by the touch coordinate transformer to the information terminal as the remote operation information,
when a change in a display direction of the screen is notified from the information terminal through the communicator, the operation region acquisition unit performs image analysis to the screen of the display on which the screen of the display direction after the change is displayed, and acquires operation region information for identifying a touch operation region corresponding to the screen of the information terminal.

22. The information processing device according to claim 16, wherein
the operation region acquisition unit starts processing to acquire the operation region information when the communication connection between the communicator and the information terminal is established.

23. The information processing device according to claim 16, wherein
when the information processing device is activated, the communicator searches for a communicably connectable information terminal, and establishes communication connection with the searched information terminal.

24. The information processing device according to claim 16, wherein
the display controller displays, on the operation screen display region, a user interface that confirms a success or failure of the calibration displayed on the screen of the information terminal,
the operation region acquisition unit acquires operation region information of the touch operation region corresponding to the operation screen display region including the user interface unit,
the touch operation acquisition unit detects a user operation performed to the user interface unit displayed on the touch panel, and acquires touch position information and a touch operation type of the user operation performed to the user interface that has been detected based on the operation region information,
the touch coordinate transformer transforms, based on the operation region information, the touch position information of the user operation performed to the user interface unit into position information corresponding to the screen of the information terminal, and
the communicator sends the position information transformed by the touch coordinate transformer and the touch operation type, as the remote operation information, to the information terminal.

25. An information processing device that includes a communicator communicably connected to an information terminal, and a display provided with a touch panel, that transforms a touch operation performed to the touch panel into remote operation information, and that remotely operates the information terminal by causing the communicator to send the remote operation information to the information terminal, the information processing device comprising:
a display controller that displays a screen of the information terminal on the display by using screen information of the information terminal received from the communicator;
an operation region acquisition unit that performs image analysis to a screen of the display on which the screen of the information terminal is displayed, and acquires operation region information for identifying a touch operation region corresponding to the screen of the information terminal;
a touch operation acquisition unit that detects the touch operation performed to the touch panel, and acquires position information of the detected touch operation based on the operation region information;
a touch coordinate transformer that transforms, based on the operation region information, the position information of the touch operation acquired by the touch operation acquisition unit into position information corresponding to the screen of the information terminal,
an operation region information storage which accumulates the operation region information acquired by the operation region acquisition unit, in association with identifying information of the corresponding information terminal, and from which the operation region information can be read by the touch operation acquisition unit and the touch coordinate transformer;
a stored information processor that, when power of the information processing device is turned OFF, acquires the operation region information and the associated identifying information of the information terminal that are stored in the operation region information storage;
a nonvolatile memory that accumulates the operation region information and the associated identifying information of the information terminal that are acquired by the stored information processor; and
an accumulated information searcher that refers to the nonvolatile memory when the communicator and the information terminal are communicably connected, and when operation region information related to the communicably connected information terminal has been accumulated, acquires the operation region information and the identifying information of the information terminal and stores the acquired information in the operation region information storage, whereas when operation region information related to the communicably connected information terminal has not been accumulated, instructs the operation region acquisition unit to perform processing to acquire the operation region information related to the information terminal,
wherein the communicator sends the position information transformed by the touch coordinate transformer to the information terminal as the remote operation information.

26. An information processing device that includes a communicator communicably connected to an information terminal and an external server, and a display provided with a touch panel, that transforms a touch operation performed to the touch panel into remote operation information, and that remotely operates the information terminal by causing the communicator to send the remote operation information to the information terminal, the information processing device comprising:
a display controller that displays a screen of the information terminal on the display by using screen information of the information terminal received from the communicator;
a touch operation acquisition unit that detects the touch operation input to the touch panel, and acquires position information of the detected touch operation based on operation region information received from the information terminal or the external server through the communicator; and
a touch coordinate transformer that transforms, based on the operation region information received from the information terminal or the external server, the position information of the touch operation acquired by the touch operation acquisition unit into position information corresponding to the screen of the information terminal,
wherein the communicator sends the position information transformed by the touch coordinate transformer to the information terminal as the remote operation information, and
the touch operation acquisition unit acquires, as the operation region information, a starting point position and a region size of a touch operation region corresponding to the screen of the information terminal displayed on the display.

27. An information terminal that is remotely controlled by an information processing device that includes a communicator communicably connected to an information terminal, and a display provided with a touch panel, that acquires position information of a touch operation input to the touch panel, and that causes the communicator to send, as remote operation information, normalization position information which is obtained by normalizing the acquired position information, the information terminal comprising:
a terminal-side communicator that is communicably connected to the information processing device;
a terminal display that displays a screen; and
an operation information processor that transforms the normalization position information received from the terminal-side communicator into a coordinate that matches a screen display size of the terminal display, and performs processing such that the transformed coordinate corresponds to an operation on the screen of the terminal display.

28. An information processing system comprising an information terminal, and an information processing device that remotely operates the information terminal,
wherein the information processing device includes:
a device-side communicator that is communicably connected to the information terminal;
a display provided with a touch panel;
a display controller that displays, on the display, a screen of the information terminal by using screen information of the information terminal received from the device-side communicator;
an operation region acquisition unit that performs image analysis to the screen of the display on which the screen of the information terminal is displayed, and acquires operation region information for identifying a touch operation region corresponding to the screen of the information terminal;
a touch operation acquisition unit that detects a touch operation input to the touch panel, and acquires position information of the detected touch operation based on the operation region information; and
a touch coordinate transformer that transforms, based on the operation region information, the position information of the touch operation acquired by the touch operation acquisition unit into position information corresponding to the screen of the information terminal, and
wherein the information terminal includes:
a terminal-side communicator that is communicably connected to the information processing device;
a terminal display that displays a screen; and
an operation information processor that performs processing such that the position information transformed by the touch coordinate transformer and received from the information processing device through the terminal-side communicator corresponds to an operation on the screen of the terminal display,
the display controller acquires screen information of the information terminal on which a calibration screen is displayed, the calibration screen being configured from an operation screen display region on which a screen to be operated is displayed, and a region outside the operation screen display region and adjacent to the operation screen display region, and displays the calibration screen of the information terminal on the display, and
the operation region acquisition unit performs image analysis to the calibration screen displayed on the display, identifies a boundary between the operation screen display region and the region outside the operation screen display region, and acquires, as the operation region information, a starting point position and a region size of a touch operation region corresponding to the operation screen display region.

29. A calibration method in which an information processing device communicably connected to an information terminal and including a display provided with a touch panel identifies a touch operation region corresponding to a screen of the information terminal displayed on the display, the calibration method comprising:
by the information processing device, acquiring screen information of the information terminal on which a calibration screen is displayed, the calibration screen being configured from an operation screen display region on which a screen to be operated is displayed, and a region outside the operation screen display region and adjacent to the operation screen display region, and displaying the calibration screen of the information terminal on the display; and
by the information processing device, performing image analysis to the calibration screen displayed on the display, identifying a boundary between the operation screen display region and the region outside the operation screen display region, and acquiring, as the operation region information, a starting point position and a region size of a touch operation region corresponding to the operation screen display region.
